(19) United States
(12) Patent Application Publication
(10) Pub. No.: US 2007/0034468 A1
(43) Pub. Date: Feb. 15, 2007

(54) Energy dissipation device with elevated action force

(75) Inventor: Andreas Kemper, Lengede (DE)

Correspondence Address: Fulbright & Jaworski L.L.P.;Fulbright Tower, Suite 5100, 1301 McKinney, Houston, TX, 77010-3095, US

(73) Assignee: Voith Turbo Scharfenberg GmbH & Co. KG, Salzgitter-Watenstedt (DE)

(21) Appl. No.: 11/493,779

(22) Filed: Jul. 26, 2006

(30) Foreign Application Priority Data
Aug. 10, 2005 (EP) EP05017411.9

(51) Int. Cl. F16F 7/12

(52) U.S. Cl. 188/377

(57) ABSTRACT

The present invention relates to an energy dissipation device with a first force-transferring element, a second force-transferring element, and a first and second energy dissipation element which are disposed in the energy dissipation device such that the force flow taking place during the transfer of the tractive and impact forces in the longitudinal direction of the energy dissipation device runs parallel through the two energy dissipation elements. By the activation behavior of the individual energy dissipation elements being chosen appropriately, the total characteristic curve of the energy dissipation device can be precisely determined in advance. In particular, the invention makes possible the construction of energy dissipation devices with force-path characteristic curves with regions of the characteristic curve, which fall off sharply. For this, characteristic curve contours are possible in particular in which, to trigger the energy dissipation device, a greater force is required than during the actual energy dissipation.

### CROSS-REFERENCE TO RELATED APPLICATIONS

The present application claims priority to European Patent Office Application No. EP05017411.9, filed Aug. 10, 2005.

### TECHNICAL FIELD

The present invention relates to an energy dissipation device.

### BACKGROUND OF THE INVENTION

The present invention relates to an energy dissipation device with a first force-transferring element, a second force-transferring element, and a first energy dissipation element, where the force-transferring elements are, with the aid of the first energy dissipation element, connected to one another in a force-locking manner such that tractive and impact forces can be transferred in the longitudinal direction of the energy dissipation device by the fact that the force flow taking place during the transfer of forces runs at least partially through the first energy dissipation element, where the first energy dissipation element is designed in such a manner that up to a determinable first amount of energy transferred by the force flow over the first energy dissipation element the force-transferring elements are essentially rigid relative to one another in the longitudinal direction of the energy dissipation device and that in case of an overshoot of the determinable first amount of energy transferred by the force flow over the first energy dissipation element the force-transferring elements are shifted relative to one another in the longitudinal direction of the energy dissipation device, where at least a part of the transferred amount of energy is absorbed and dissipated by the first energy dissipation element.

Energy dissipation devices of this type are known in principle from the state of the art and are, for example, used in rail vehicle technology as a device protecting against impacts. As a rule such a device protecting against impacts comprises a combination of a tractive/impact device (spring apparatus) and an energy dissipation device, where the device protecting against impacts protects the vehicle, in particular even at greater speeds of impact. Along with this it is, for example, provided that the tractive and impact device absorbs tractive and impact forces up to a defined magnitude and conducts forces extending beyond this into the undercarriage of the vehicle. In this way tractive and impact forces which occur during the normal operation of the vehicle, e.g. in the case of a multi-member vehicle between individual cars, are in fact absorbed in this impact protection device formed as a rule in such a manner that it can be regenerated but in case of an overshoot of the operating load of the tractive and impact device on the contrary, such as in a collision of the vehicle with an obstacle or in case of abrupt braking of the vehicle, the impact protection device formed in such a manner that it can be regenerated and the hinge connection provided in given cases between the individual cars may be destroyed or damaged. In each case the tractive and impact device is not sufficient for the dissipation of the incident energy. Thus this impact protection device is then no longer incorporated in the energy dissipation concept of the entire vehicle so that the occurring impact energy is transferred directly to the frame of the vehicle. With this, it is exposed to extreme stresses and under certain circumstances is damaged or even entirely destroyed. In the case of rail vehicles there is the danger of derailing.

With the goal of protecting the undercarriage of the vehicle against damage in case of severe collision impacts, an energy dissipation element formed in such a manner that it can be destroyed or regenerated comes into use frequently, said energy dissipation element, for example, being designed in such a manner that after exhaustion of the effective dissipation of the tractive and impact device the energy dissipation element activates and the energy transferred by the force flow over the energy dissipation element is at least partially absorbed and dissipated. As energy dissipation element, for example, deformation tubes come into consideration in which through a defined deformation of an element in a destructive manner the impact energy is converted into work of deformation and heat.

An energy dissipation element in which a deformation tube is used is distinguished by the fact that it has a defined activation force without spikes in the force. However, energy dissipation elements formed in such a manner that they can be regenerated are also known from the state of the art. Examples of this are gas-hydraulic buffers with a regenerable or self-restoring mode of operation. Energy dissipation elements which are based on a gas-hydraulic mode of operation have as a rule a low activation force, are initially secured in position in a weak manner, and react, in contradistinction to a deformation tube, in a manner dependent on speed.

Along with energy dissipation elements, which are based on a gas-hydraulic mode of operation, energy dissipation elements are also known which are based on a hydrostatic mode of operation and which likewise act in a regenerable (self-restoring) manner. Hydrostatically operating energy dissipation elements have, in contradistinction to energy dissipation elements operating in a gas-hydraulic mode, a high activation force and are initially secured in position in a strong manner.

In FIG. 1, known from the state of the art, an energy dissipation device 100 is shown in which a deformation tube 30 is used. The lower half of the energy dissipation device 100 is shown in FIG. 1 in a longitudinally sectioned representation. This energy dissipation device 100 known from the state of the art comprises a first force-transferring element 20 and a second force-transferring element 40, which are connected to one another with the aid of an energy dissipation element 30 (deformation tube) in a force-locking manner such that tractive and impact forces can be transferred in the longitudinal direction of the energy dissipation device 100. In the transfer of the tractive and impact forces the force flow from the first force-transferring element 20 to the second force-transferring element 40 runs essentially completely over the energy dissipation element 30 formed as a deformation tube. In FIG. 1 a normal state of operation is shown in which the energy transferred over the energy dissipation device 100 by the tractive and impact forces is less than the amount of energy characteristic for the activation of the energy dissipation element 30 (deformation tube). As can be seen, the force-transferring elements 20, 40 are essentially rigid relative to one another in the longitudinal direction of the energy dissipation device 100.

In FIG. 2 a state after the activation of the energy dissipation element 100 according to FIG. 1 is shown. As already mentioned previously, the energy dissipation device 100 is designed in such a manner that during the transfer of tractive and impact forces the force flow taking place from the first force-transferring element 20 to the second force-transferring element 40 (and vice versa) runs essentially completely over the deformation tube 30. The deformation tube 30 itself is designed in such a manner that in case of an overshoot of an amount of energy transferred by the force flow over the deformation tube 30 a plastic deformation of the element 30 takes place so that the force-transferring elements 20, 40 are shifted relative to one another in the longitudinal direction of the energy dissipation element 100, whereby as a consequence of the destructible deformation of the deformation tube 30 at least a part of the transferred amount of energy is absorbed by the first energy dissipation element 30 and converted into work of deformation and heat and is thus dissipated.

An energy dissipation device of this type, as is represented by way of example in FIGS. 1 and 2, has a characteristic curve running essentially in the form of a rectangle, whereby a maximum energy uptake after the activation of the energy dissipation element is ensured. Furthermore, an energy dissipation element in which a deformation element formed to be destructible is integrated is distinguished by a defined activation force without spikes in the force.

Due to the fact that energy dissipation devices in which an energy dissipation element formed to be destructible is integrated have as a rule a rectangular characteristic curve predefined by the energy dissipation element (deformation tube), it is not possible to adapt such energy dissipation devices precisely to certain applications. For this it would be required to design the force-path characteristic curve of the energy dissipation device accordingly in order to enable a predictable, defined energy dissipation.

The use of energy dissipation devices in which an energy dissipation element operating hydrostatically is used, and which therefore have an characteristic curve which increases essentially linearly, is also frequently not suitable for many applications since the maximum energy uptake of the corresponding energy dissipation elements is often too small.

In particular, there is in many applications a need to use an energy dissipation device which is distinguished on the one hand by a maximum energy uptake and on the other hand by an elevated activation force. Thus it is often desirable that the energy dissipation device is only activated at an elevated activation force, that is, loses its function as a rigid connecting member for the transfer of force at least partially and absorbs a part of the energy transferred by the force flow over the energy dissipation device, where, however, after the activation of the energy dissipation device an additional amount of energy transferred by the force flow is also absorbed when the force flow is smaller than the characteristic force flow necessary for the initial activation of the energy dissipation device.

In order to realize this objective it would be conceivable to assume an energy dissipation device in which a traditionally formed energy dissipation element operating in a destructible manner (deformation element) is integrated, and which, as a consequence of the rectangular curve characteristic for such energy dissipation elements (deformation elements), is distinguished by a maximum energy uptake, where furthermore shearing elements are provided transverse to the direction of force. The shearing elements serve as rigid connecting members up to the determinable amount of energy transferred by the force flow over the shearing elements, where however in case of an overshoot of the amount of energy characteristic for the shearing elements said rigid connecting members completely lose their function as connecting members and permit activation and thus a deformation of the energy dissipation element (deformation element) provided in the energy dissipation device and formed to operate in a destructible manner. In such a realization a force-path characteristic curve would, with a suitable design of the shearing elements as well as the energy dissipation element, indeed be achievable, said force-path characteristic curve being distinguished by an elevated activation force. However, such a realization can frequently be used in practice only to a limited extent since it is not permissible to apply the fundamentally necessary initial securement in position of the energy dissipation element (deformation element) to such shearing elements. Since specifically the energy dissipation element (deformation element) is designed in such a manner that in normal operation it provides a force-locking connection between the first and second energy dissipation element, where the force-transferring elements connected in such a manner are essentially rigid relative to one another in the longitudinal direction of the energy dissipation device, it is fundamentally necessary to accordingly secure the deformation element or energy dissipation element in position between the force-transferring elements.

### BRIEF SUMMARY OF THE INVENTION

The present invention relates to an energy dissipation device with a first force-transferring element, a second force-transferring element, and a first energy dissipation element, where the force-transferring elements are, with the aid of the first energy dissipation element, connected to one another in a force-locking manner such that tractive and impact forces can be transferred in the longitudinal direction of the energy dissipation device by the fact that the force flow taking place during the transfer of forces runs at least partially through the first energy dissipation element, where the first energy dissipation element is designed in such a manner that up to a determinable first amount of energy transferred by the force flow over the first energy dissipation element the force-transferring elements are essentially rigid relative to one another in the longitudinal direction of the energy dissipation device and that in case of an overshoot of the determinable first amount of energy transferred by the force flow over the first energy dissipation element the force-transferring elements are shifted relative to one another in the longitudinal direction of the energy dissipation device, where at least a part of the transferred amount of energy is absorbed and dissipated by the first energy dissipation element.

On the basis of the problem described, the objective of the present invention is to extend an energy dissipation device of the type stated in the introduction in such a manner that for one thing the impact energy transferred over the energy dissipation device by an extreme impact can be reliably dissipated and that for another thing the force-path characteristic curve of the energy dissipation device can be adapted to individual applications as precisely as possible.

This objective is realized with an energy dissipation device of the type stated in the introduction by the fact that the energy dissipation device further comprises at least one second energy dissipation element which is disposed in relation to the force-transferring elements in such a manner that tractive and impact forces can be transferred in the longitudinal direction of the energy dissipation device by the fact that the force flow taking place during the transfer of forces runs at least partially through the second energy dissipation element, where the second energy dissipation element is designed in such a manner that up to a determinable second amount of energy transferred by the force flow through the second energy dissipation element the force-transferring elements are essentially rigid relative to one another in the longitudinal direction of the energy dissipation device and that in case of an overshoot of the determinable second amount of energy transferred by the force flow over the second energy dissipation element the force-transferring elements are shifted relative to one another in the longitudinal direction of the energy dissipation device, and where the first and second energy dissipation elements are disposed so as to be parallel to one another in such a manner that the force flow taking place during the transfer of the tractive and impact forces in the longitudinal direction of the energy dissipation device runs parallel through the first and second energy dissipation elements.

The realization according to the invention has, as is presented in the following, an entire series of significant advantages with respect to the energy dissipation device known from the state of the art and explained above. Due to the fact that in the energy dissipation device according to the invention two energy dissipation elements disposed so as to be parallel to one another are provided, each of which activates at a (determinable) amount of energy specific for its respective energy dissipation element, it is possible to precisely adapt the characteristic curve of the energy dissipation device to individual applications. Thus it is possible with the realization according to the invention to determine in advance the (total) activation force characteristic for the energy dissipation device since it is defined by the total of the activation forces or activation energies specific for the two energy dissipation elements. Expressed another way this means that the activation force characteristic for the energy dissipation device can be precisely specified by the activation forces of the respective energy dissipation elements being accordingly determined in advance. Due to the fact that after the activation of the energy dissipation device the first energy dissipation element as well as the second energy dissipation element each absorb and dissipate at least a part of the amount of energy transferred over the energy dissipation device, the energy dissipation process of the energy dissipation device can furthermore be determined in advance and in particular can be especially adapted to certain applications. At this point let it be pointed out that the respective energy dissipation element absorbs and dissipates that partial energy amount which is transferred by tractive and impact forces in the longitudinal direction of the energy dissipation device and corresponds to the integral of the force-path curve characteristic for the respective energy dissipation element. Here it is to be taken into account that, as a consequence of the, according to the invention, parallel disposition of the individual energy dissipation elements, the total force flow which is transferred by the energy dissipation device or by the first and second energy dissipation element is divided accordingly onto the first and second energy dissipation element so that over each individual energy dissipation element only a corresponding partial amount of the total force flow, and thus the total energy, is transferred. Along with this, it is to be taken into account that according to the invention the first and second energy dissipation elements are designed in such a manner that up to a determinable first or second amount of energy transferred by the force flow over the respective energy dissipation element the force-transferring elements are essentially rigid relative to one another in the longitudinal direction of the energy dissipation device. By the expression “essentially rigid” in this specification it is meant that between the first and second force-transferring elements there is, in the ideal case, no play, even before the activation of the energy dissipation device.

Advantageous extensions of the energy dissipation device according to the invention are specified in the subordinate claims.

Thus it is provided in a particularly preferred form of embodiment of the energy dissipation device according to the invention that the energy dissipation elements connected so as to be parallel are designed in such a manner that the force flow taking place during the transfer of the tractive and impact forces in the longitudinal direction of the energy dissipation device runs essentially completely through the energy dissipation elements. In this way it can be achieved that the energy dissipation of the energy dissipation device can be precisely determined in advance by the design of the individual energy dissipation elements. Consequently it is possible to provide an energy dissipation device with a (total) characteristic curve which can be precisely determined and in particular adapted to individual applications, where this (total) characteristic curve is specified nearly exclusively by a superposition of the individual characteristic curves of the energy dissipation elements integrated in the energy dissipation device. Obviously however, it is also conceivable that the force flow taking place during the transfer of the tractive and impact forces in the longitudinal direction of the energy dissipation device runs only partially through the energy dissipation elements, where the remaining part of the force flow is, with the aid of suitable devices, conducted past to the energy dissipation elements so that this part is transferred directly by the force-transferring elements.

In order to make possible an energy dissipation device's characteristic curve contour which can be determined in advance and in particular adapted as precisely as possible to a certain application, it is provided in a particularly preferred extension of the previously described form of embodiment that the force flow taking place during the transfer of the tractive and impact forces in the longitudinal direction of the energy dissipation device runs essentially completely through the energy dissipation elements connected so as to be parallel, where the portion of the amount of energy transferred by the force flow through the first and/or through the second energy dissipation element can be determined in advance. The particular advantages of this form of embodiment are in particular to be seen in the fact that, despite the parallel disposition of the energy dissipation determinable first or second amount of energy transferred by the force flow over the respective energy dissipation element the force-transferring elements are essentially rigid relative to one another in the longitudinal direction of the energy dissipation device. By the expression “essentially rigid” in this specification it is meant that between the first and second force-transferring elements there is, in the ideal case, no play, even before the activation of the energy dissipation device.

Advantageous extensions of the energy dissipation device according to the invention are specified in the subordinate claims.

Thus it is provided in a particularly preferred form of embodiment of the energy dissipation device according to the invention that the energy dissipation elements connected so as to be parallel are designed in such a manner that the force flow taking place during the transfer of the tractive and impact forces in the longitudinal direction of the energy dissipation device runs essentially completely through the energy dissipation elements. In this way it can be achieved that the energy dissipation of the energy dissipation device can be precisely determined in advance by the design of the individual energy dissipation elements. Consequently it is possible to provide an energy dissipation device with a (total) characteristic curve which can be precisely determined and in particular adapted to individual applications, where this (total) characteristic curve is specified nearly exclusively by a superposition of the individual characteristic curves of the energy dissipation elements integrated in the energy dissipation device. Obviously however, it is also conceivable that the force flow taking place during the transfer of the tractive and impact forces in the longitudinal direction of the energy dissipation device runs only partially through the energy dissipation elements, where the remaining part of the force flow is, with the aid of suitable devices, conducted past to the energy dissipation elements so that this part is transferred directly by the force-transferring elements.

In order to make possible an energy dissipation device's characteristic curve contour which can be determined in advance and in particular adapted as precisely as possible to a certain application, it is provided in a particularly preferred extension of the previously described form of embodiment that the force flow taking place during the transfer of the tractive and impact forces in the longitudinal direction of the energy dissipation device runs essentially completely through the energy dissipation elements connected so as to be parallel, where the portion of the amount of energy transferred by the force flow through the first and/or through the second energy dissipation element can be determined in advance. The particular advantages of this form of embodiment are in particular to be seen in the fact that, despite the parallel disposition of the energy dissipation elements, the respective force flows conducted by a certain energy dissipation elements can be determined with the aid of a suitable measure of construction in such a manner that they have different amounts. Due to this it is possible to use energy dissipation elements, each with a different characteristic curve contour in parallel in the energy dissipation device according to the invention, where by a suitable division of the energy transferred by the force flow through the individual energy dissipation elements the sensitivity of the energy dissipation device as well as the contour of the characteristic curve can be controlled in almost any manner.

In a preferred, even if known in part, e.g. from rail vehicle technology, extension of the previously stated forms of embodiment of the energy dissipation device according to the invention it is provided that the first and/or second energy dissipation element is/are formed so as to be destructible. Due to the fact that according to the invention the energy dissipation elements are disposed so as to be parallel to one another in the energy dissipation device so that the total force flow in the transfer of the tractive and impact forces from the first force-transferring element to the second force-transferring element (and vice versa) is divided accordingly onto the energy dissipation elements and due to the fact that the energy dissipation device's (total) characteristic curve resulting therefrom is formed by a superposition of the (individual) characteristic curve contours of the respective energy dissipation elements, it is possible with this preferred form of embodiment of the energy dissipation device according to the invention to define, and adapt to a special application, the (total) characteristic curve contour in nearly any manner in advance. As stated in the introduction, for example, energy dissipation elements, which comprise a deformation element formed so as to be destructible, are distinguished by the fact that they have a nearly rectangular characteristic curve contour. On the other hand, for example, energy dissipation elements formed so as to be regenerable which, for example, comprise a buffer element operating hydrostatically or gas-hydraulically are characterized by the fact that their characteristic curve contour increases linearly. Since the energy dissipation elements formed so as to be destructible and regenerable in this form of embodiment's energy dissipation device according to the invention are disposed so as to be parallel to one another in the transferred force flow, the energy dissipation device's (total) characteristic curve contour can ,be determined in nearly any manner in advance. Obviously however, other energy dissipation elements can also be used here, said energy dissipation elements being based on another principle of operation.

In an advantageous embodiment variant of the energy dissipation device according to the invention an energy dissipation element formed so as to be regenerable is furthermore provided. Such an energy dissipation element formed so as to be regenerable can, for example, be embodied in the form of a frictional spring, spherolastic spring, or a rubber spring integrated in the energy dissipation device. Providing an additional energy dissipation element formed so as to be regenerable in the energy dissipation device has the advantage that this energy dissipation element can take up tractive and impact forces up to a defined magnitude and can conduct forces extending beyond this to the energy dissipation elements. The first and second energy dissipation elements activate when the forces extending beyond the operational range of the energy dissipation element formed so as to be regenerable exceed the (total) activation force characteristic for the energy dissipation device. An advantage of this form of embodiment is to be seen in the fact that the total characteristic curve contour of the energy dissipation device can be adapted still better to a predefined course of events. Due to the fact that in this form of embodiment of the energy dissipation device according to the invention a part of the forces (energy) transferred by the force-transferring elements is absorbed even before the (total) activation force characteristic for the energy dissipation device, it can be achieved that the characteristic curve contour of the energy dissipation device has, with suitable design of the energy dissipation element formed so as to be regenerable, for example, no discontinuities. The additional energy dissipation element formed so as to be regenerable can be disposed parallel to first and second energy dissipation elements in the energy dissipation device. However, it would also be conceivable to connect this additional energy dissipation element formed so as to be regenerable to the first and second energy dissipation elements.

In a particularly preferred extension of the previously stated forms of embodiment of the energy dissipation device according to the invention it is provided that the second energy dissipation element comprises a plurality of energy dissipation elements. Each energy dissipation element in this plurality of energy dissipation elements can have a different activation force and energy dissipation capacity. However, it would also be conceivable that the energy dissipation elements in this plurality of energy dissipation elements are all formed so as to be identical to one another. By, if needed, all the energy dissipation elements in this plurality of energy dissipation elements being disposed so as to be parallel to one another with respect to the force flow which is transferred by the force-transferring elements, it is possible to predefine the (total) characteristic curve contour of the energy dissipation device in nearly any manner since a plurality of graduations is made possible by the plurality of energy dissipation elements in the (total) characteristic curve contour.

In a particularly advantageous extension of the previously stated forms of embodiment of the energy dissipation device according to the invention it is provided that the part of the transferred amount of energy absorbed and dissipated by the first and/or second energy dissipation element can be determined in advance. Through this particular development, in which the energy dissipation capacity of the individual energy dissipation elements can be determined in advance, the characteristic curve contour of the individual energy dissipation elements can be adapted in an optimal manner to a predefined course of events. In particular, it is possible hereby to form an energy dissipation device, which has an activation force, which is elevated in comparison to the characteristic curve contour.

It has proven to be an additional advantage that in a particularly preferred extension of the stated forms of embodiment the energy dissipation elements are disposed in the energy dissipation device in such a manner that after an overshoot of a maximum amount of energy transferred by tractive and impact forces in the longitudinal direction of the energy dissipation device they activate simultaneously and each simultaneously absorb and dissipate a part of the maximum amount of energy. With this, the maximum amount of energy transferred by tractive and impact forces in the longitudinal direction of the energy dissipation device after an overshoot corresponds to the total of the first determinable amount and the second determinable amount of the respective energy dissipation elements.

In a possible realization of the energy dissipation device according to the invention the first force-transferring element has a first supporting body via which tractive and impact forces are conducted to the second force-transferring element. The second force-transferring element further has a second supporting body onto which the tractive and impact forces transferred by the first force-transferring element are transferred. Furthermore, the first and/or second energy dissipation element each comprise at least one deformation body via which the tractive and impact forces transferred from the first force-transferring element to the second force-transferring element (and vice versa) are transferred. By the term “supporting body” used herein is meant any body whose primary objective consists in transferring forces and which is formed in such a manner that it, even in case of an overshoot of the maximum activation force characteristic for the energy dissipation element, retains its function as a supporting body as before. By the term “deformation body” used herein is meant on the contrary a body which up to an amount of energy characteristic for this deformation body serves as supporting element or force-transferring element (and thus holds the force-transferring elements in a relatively rigid relation to one another), where, however, the deformation body is designed in such a manner that after an overshoot of an energy or force characteristic for this deformation body it loses, at least in part, its function as a force-transferring element and is deformed, whereby at least a part of the transferred energy is converted into heat of deformation and thus is dissipated in the energy concept of the energy dissipation device.

In an advantageous manner in the latter possible realization of the energy dissipation device according to the invention the first supporting body is formed as a hollow body, in particular as a tube, and the second supporting body is formed as a rod which projects at least partially into the hollow body. Thereby a particularly compact energy dissipation device is possible. Obviously however, other technological realizations are also conceivable here.

In order to achieve the fundamentally necessary initial securement of the energy dissipation elements in position between the two force-transferring elements, it is provided in a particularly preferred form of embodiment that the energy dissipation device comprises in addition at least one clamping element in order to initially secure the energy dissipation elements in position for the tractive and impact forces occurring in normal operation in a manner such that they are free of play between the force-transferring elements, at least in part. The energy dissipation elements' play-free initial securement in position in the energy dissipation device is advantageous since in this way a predictable course of energy dissipation is made possible. In particular, it can be ensured in this way that even those forces, which have, along with a force component in the longitudinal direction of the energy dissipation device, also a force component in the transverse direction of the energy dissipation device can be reliably and predictably absorbed and dissipated with the aid of the energy dissipation elements.

In a possible realization of the latter preferred form of embodiment of the energy dissipation device which is in accordance with the invention and comprises at least one clamping element and in which the first force-transferring element has a first supporting body via which the tractive and impact forces are conducted to the second force-transferring element and in which the second force-transferring element in addition has a second supporting body onto which the tractive and impact forces are transferred from the first force-transferring element, it is provided that the clamping element is formed on the first and/or the second supporting body. However, it would also be conceivable here that the clamping element is formed as a projection in order to enable in this way the initial securement in position of the energy dissipation elements. Obviously however, other forms of embodiment are also conceivable here.

As a preferred use of the energy dissipation device according to the invention according to one of the forms of embodiment explained above, its use in a hinge or coupling arrangement of a multi-member vehicle, e.g. a rail vehicle, is provided. Other types of use would also be conceivable here.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying FIGURES. It is to be expressly understood, however, that each of the FIGURES is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a exemplary energy dissipation device from the state of the art, which is shown in part in a sectional representation, and which is in a normal state of operation;

FIG. 2 illustrates the energy dissipation device according to FIG. 1 in a state after the activation of the energy dissipation device;

FIG. 3 is an advantageous form of embodiment of the energy dissipation device according to the invention in a normal operating state, that is, before the activation of the energy dissipation elements provided in the energy dissipation device;

FIG. 4 is a sectional representation of the energy dissipation device according to the invention and according to FIG. 3; and

FIG. 5 illustrates the force-path characteristic curve contour of the energy dissipation device according to the invention and according to FIG. 3.

### DETAILED DESCRIPTION OF THE INVENTION

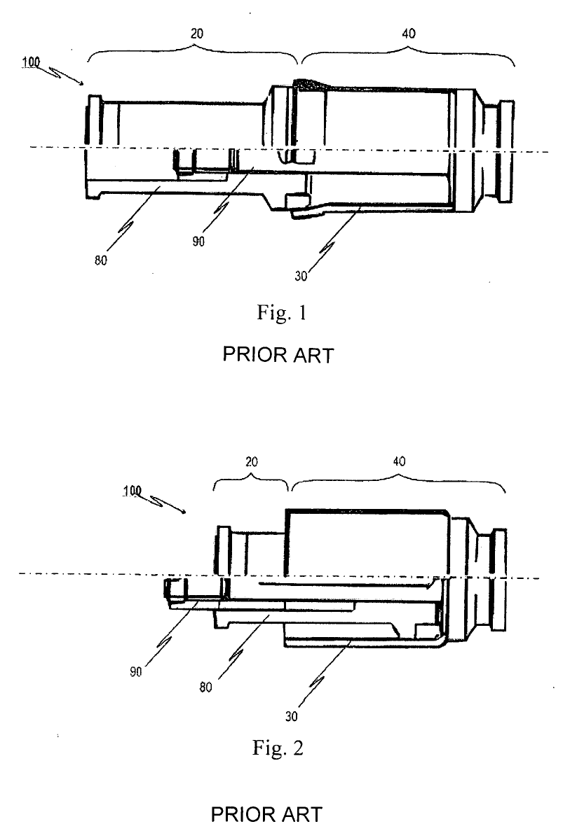

FIG. 1 shows an energy dissipation device 100 from the state of the art, where the lower half of the energy dissipation device 100 is represented in partial section. The energy dissipation device 100 comprises a first force-transferring element 20, a second force-transferring element 40, and an energy dissipation element 30 which is formed here as a deformation tube. The force-transferring elements 20, 40 are connected to one another via the energy dissipation element 30 in a force-locking manner such that tractive and impact forces can be transferred in the longitudinal direction of the energy dissipation device 100. In the transfer of the forces the corresponding force flow runs nearly completely through the energy dissipation element 30 integrated in the energy dissipation device 100. The first force-transferring element 20 has a first supporting body 80 which is embodied here as a tubular element. The second force-transferring element 40 has a second supporting body 90 embodied as a rod. The first as well as the second supporting elements 80, 90 are embodied as pure force-transferring elements which (in the ideal case) are not deformed and thus absorb no energy.

In FIG. 1 a state is shown in which the amount of energy transferred by the force flow over the energy dissipation element 30 integrated in the energy dissipation device 100 has still not exceeded the activation energy level characteristic for the energy dissipation element 30. Consequently, in this state the force-transferring elements 20, 40 are essentially rigid relative to one another in the longitudinal direction of the energy dissipation device 100.

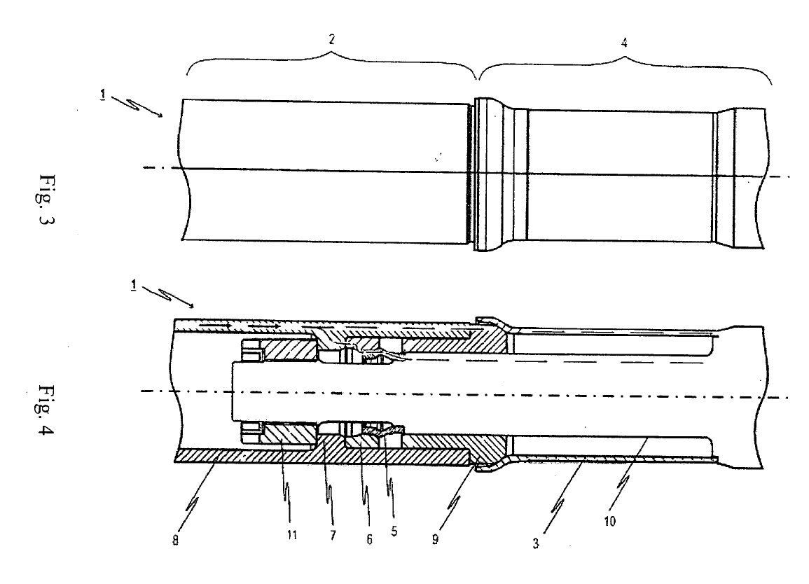

FIG. 2 shows the traditional energy dissipation device 100 represented in FIG. 1 after the activation of the energy dissipation element 30. In this state the amount of energy transferred by the force flow over the energy dissipation element 30 has already exceeded the activation energy level characteristic for activation of the energy dissipation element 30 so that the energy dissipation element 30, which is formed here as a deformation tube, has been deformed and as a consequence has absorbed and dissipated a part of the energy transmitted by the force-transferring elements 20, 40. In the state represented in FIG. 2 the force-transferring elements 20, 40 have thus already been shifted relative to one another in the longitudinal direction of the energy dissipation device 100.

In FIG. 3 an advantageous form of embodiment of the energy dissipation device 1 according to the invention is shown while in FIG. 4 a sectional representation thereof is represented. The energy dissipation device 1 according to the invention comprises a first force-transferring element 2 and a second force-transferring element 4 which are designed to transfer tractive and impact forces in the longitudinal direction of the energy dissipation device 1. Therein it is provided that the first force-transferring element 2 has a first supporting body 8 formed as a tube and the second force-transferring element 4 has a second supporting body 10 formed as a rod. The second supporting body 10 formed as a rod projects at least partially into the first supporting body 8 formed as a tube, where the first supporting body 8 is supported with the aid of an annular projection 7 and with the aid of a sleeve-like element 9 on the second supporting body 10.

Furthermore, two energy dissipation elements 3, 9; 5, 6 disposed so as to be parallel to one another are disposed in the energy dissipation device 1 according to the invention. In the particularly preferred form of embodiment represented the energy dissipation elements 3 and 5 are each provided as energy dissipation elements formed in the form of a deformation element and so as to be destructible. In the transfer of tractive and impact forces over the energy dissipation device 1 the corresponding force flow is conducted in parallel through the first and second energy dissipation elements 3, 9; 5, 6. Consequently, the energy transferred by tractive and impact forces is conducted completely over both energy dissipation elements 3, 9; 5, 6.

Along with this the first energy dissipation element 3, 9 is formed by a deformation body 3 and a body 9 which, on activation of the energy dissipation element, deforms the deformation body 3. In the same manner the second energy dissipation element 5, 6 is formed by a deformation body 5 and a corresponding counter body 6.

Along with this it is provided that the first energy dissipation element 3, 9 has activation behavior characteristic for this energy dissipation element, by which it is to be understood that this energy dissipation element 3, 9 is essentially stable in form up to a first determinable amount of energy E1 transferred by the force flow over this energy dissipation element 3, 9, whereas after an overshoot of the characteristic amount of energy E1 transferred by the force flow over this energy dissipation element 3, 9 an (intentional) deformation of the energy dissipation element occurs, as a consequence of which at least a part of the amount of energy transferred over the energy dissipation element 3, 9 is converted into work of deformation and heat.

The second energy dissipation element 5, 6 is also embodied in the same manner, said second energy dissipation element having activation behavior characteristic for this energy dissipation element. In the preferred form of embodiment, shown in FIG. 4, of the energy dissipation device 1 according to the invention, the two energy dissipation elements 3, 9; 5, 6 are disposed in such a manner that the force flow taking place during the transfer of the tractive and impact forces in the longitudinal direction of the energy dissipation device 1 runs essentially completely through the energy dissipation elements 3, 9; 5, 6. Along with this it is provided that essentially the same portion of the amount of the energy transferred by the force flow runs through both energy dissipation elements 3, 9; 5, 6.

In the preferred form of embodiment the first and second energy dissipation elements 3, 9; 5, 6 are each formed as a deformation tube or deformation sleeve. By, for example, setting the wall thickness of these deformation tubes the activation behavior characteristic for the respective energy dissipation element can be determined in advance. In the form of embodiment represented, the wall thicknesses of the first and second energy dissipation elements 3, 9; 5, 6 formed as a deformation tube are essentially identical. However, the energy dissipation elements 3, 9; 5, 6 are distinguished by the fact that the first energy dissipation elements 3, 9 is formed by an essentially longer deformation tube than the second energy dissipation element 5, 6.

The total activation force (E1+E2) which is required so that the energy dissipation device 1 absorbs at least a part of the energy transferred by the first and second force-transferring elements 2, 4 is formed by the addition of the individual triggering forces (E1, E2) of the first and second energy dissipation elements 3, 9; 5, 6. Due to the different lengths of the first and second energy dissipation elements 3, 9; 5, 6 formed as a deformation tubes, the path of deformation of the second energy dissipation element 5, 6 is significantly shorter than that of the first energy dissipation element 3, 9. Expressed in another way this means that the transferred energy's part absorbed and dissipated by the first and second energy dissipation elements 3, 9; 5, 6 respectively can be determined in advance. Thus, the absorbed and dissipated part of the transferred amount of energy in the case of an energy dissipation element which is formed from a shorter deformation tube, is less than the absorbed and dissipated part of the amount of energy transferred by an energy dissipation element if this energy dissipation element is formed by a longer deformation tube with the same thickness.

In the energy dissipation device represented in FIGS. 3 and 4 a clamping element 11 is furthermore formed at the second supporting body 10 of the force-transferring element 4, where said second supporting body is formed as a rod. This clamping element 11 serves to initially secure the entire energy dissipation device 1 against the forces occurring in normal operation. Along with this, the individual energy dissipation elements 3, 9; 5, 6 are initially secured with the clamping element 11 without play between the force-transferring elements 2, 4. Thereby the construction of compact, low-maintenance energy systems with almost any force-path characteristic curves is made possible.

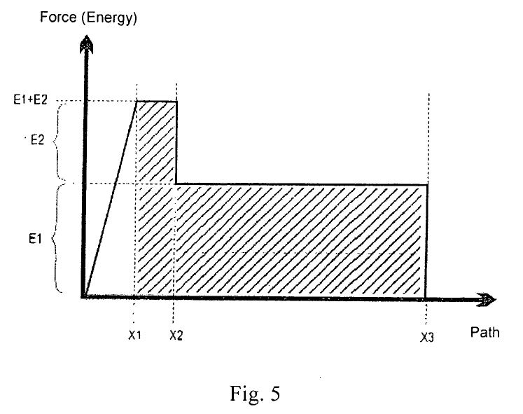

In FIG. 5 the force-path characteristic curve of the energy dissipation device 1 represented in FIGS. 3 and 4 is represented. However, the curve of the increase of force (up to X1) results therein not from the energy dissipation device but rather from elastic elements mounted outside of it. On reaching or exceeding the triggering force (E1+E2) the energy dissipation elements 3, 9; 5, 6 are deformed simultaneously. Due to the short path of deformation of the second energy dissipation element 5, 6 the energy uptake of this energy dissipation element 5, 6 is terminated shortly after the beginning of the deformation (X2) so that the additional energy uptake is done exclusively by the first energy dissipation element 3, 9. With this, the triggering force (E1+E2) follows from the addition of the individual triggering forces (E1, E2) of the energy dissipation elements 3, 9; 5, 6.

The integral under the curve contour represented in FIG. 5 represents the energy absorbed by the energy dissipation device. In detail, represented schematically by the hatched surface is the amount of energy, which is absorbed by the energy dissipation elements, integrated in the energy dissipation device and is converted into energy of deformation (heat). In the partial area between X1 and X2 the (total) energy absorbed by the energy dissipation device follows from the superposition of the (individual) amount of energy absorbed by each of the first and second energy dissipation elements. At X2 the second energy dissipation element formed, for example, as a deformation element has been completely deformed and has absorbed the maximum amount of energy corresponding to this energy dissipation element. Between X2 and X3 only one energy uptake by the first energy dissipation element takes place.

Let it be noted that the embodiment of the invention is not restricted to the embodiment example described in FIGS. 3 and 4 but rather is also possible in a plurality of variants. In particular, it is conceivable to integrate a plurality of second energy dissipation elements in the energy dissipation device in order thus to make possible a nearly arbitrarily adjustable characteristic curve of the energy dissipation device.

1. An energy dissipation device comprising
a first force-transferring element;
a second force-transferring element;
a first energy dissipation element;
where the first and second force-transferring elements are, with the aid of the first energy dissipation element, connected to one another in a force-locking manner such that tractive and impact forces can be transferred in the longitudinal direction of the energy dissipation device wherein the force flow taking place during the transfer of forces runs at least partially through the first energy dissipation element, where the first energy dissipation element is designed in such a manner that for up to a determinable first amount of energy transferred by the force flow over the first energy dissipation element, the first and second force-transferring elements are essentially rigid relative to one another in the longitudinal direction of the energy dissipation device and in case of an overshoot of the determinable first amount of energy transferred by the force flow over the first energy dissipation element, the force-transferring elements are shifted relative to one another in the longitudinal direction of the energy dissipation device, where at least a part of the transferred amount of energy is absorbed and dissipated by the first energy dissipation element;
wherein the energy dissipation device further comprises at least one second energy dissipation element which is disposed in relation to the first and second force-transferring elements in such a manner that tractive and impact forces are transferred in the longitudinal direction of the energy dissipation device wherein the force flow taking place during the transfer of forces runs at least partially through the at least one second energy dissipation element, where the at least one second energy dissipation element is designed in such a manner that for up to a determinable second amount of energy transferred by the force flow through the at least one second energy dissipation element, the first and second force-transferring elements are essentially rigid relative to one another in the longitudinal direction of the energy dissipation device and in case of an overshoot of the determinable second amount of energy transferred by the force flow over the at least one second energy dissipation element, the first and second force-transferring elements are shifted relative to one another in the longitudinal direction of the energy dissipation device, and where the first and at least one second energy dissipation elements are disposed so as to be parallel to one another in such a manner that the force flow taking place during the transfer of the tractive and impact forces in the longitudinal direction of the energy dissipation device runs parallel through the first and second energy dissipation elements,

2. The energy dissipation device of claim 1, wherein:
the force flow taking place during the transfer of the tractive and impact forces in the longitudinal direction of the energy dissipation device runs essentially completely through the first energy dissipation elements and the at least one second energy dissipation elements connected so as to be parallel.

3. The energy dissipation device of claim 1, wherein:
the force flow taking place during the transfer of the tractive and impact forces in the longitudinal direction of the energy dissipation device runs essentially completely through the first energy dissipation element and the at least one second energy dissipation elements connected so as to be parallel, where the portion of the amount of energy transferred by the force flow through the first and/or through the at least one second energy dissipation element can be determined in advance.

4. The energy dissipation device of claim 1 wherein:
the first and/or at least one second energy dissipation element is formed so as to be destructible or regenerable.

5. The energy dissipation device of claim 1, wherein:
furthermore at least one energy dissipation element formed so as to be regenerable is provided.

6. The energy dissipation device of claim 1 wherein:
the at least one second energy dissipation element comprises a plurality of energy dissipation elements.

7. The energy dissipation device of claim 1 wherein:
the part of the transferred amount of energy absorbed and dissipated by the first energy dissipation element and/or the at least one second energy dissipation element can be determined.

8. The energy dissipation device of claim 1 wherein:
the first energy dissipation element and the at least one second energy dissipation elements are disposed in the energy dissipation device in such a manner that after an overshoot of a maximum amount of energy transferred by tractive and impact forces in the longitudinal direction of the energy dissipation device they activate simultaneously and each simultaneously absorb and dissipate at least a part of the maximum amount of energy, where the maximum amount of energy corresponds to the total of the first determinable amount and the second determinable amount of the energy.

9. The energy dissipation device of claim 1 wherein:
the first force-transferring element comprises a first supporting body via which the tractive and impact forces are conducted to the second force-transferring element;
the second force-transferring element comprises a second supporting body onto which tractive and impact forces from the first force-transferring element are transferred; and
the first energy dissipation element and/or at least one second energy dissipation elements comprise deformation bodies via which the tractive and impact forces are transferred from the first force-transferring element to the second force-transferring element and vice versa.

10. The energy dissipation of claim 9, wherein:
the first supporting body comprises a hollow body, in particular a tube; and
the second supporting body comprises a rod, which projects at least partially into the hollow body.

11. The energy dissipation device of claim 1 further comprising:
at least one clamping element configured to initially secure the first energy dissipation element and the at least one second energy dissipation elements in position for the tractive and impact forces occurring in normal operation in a manner such that they are free of play between the first and second force-transferring elements, at least in part.

12. The energy dissipation device of claim 11 wherein:
the first force-transferring element comprises a first supporting body via which the tractive and impact forces are conducted to the second force-transferring element; and
the second force-transferring element comprises a second supporting body onto which tractive and impact forces from the first force-transferring element are transferred;
wherein the clamping element is formed on the first and/or second supporting body.

13. A method of use of the energy dissipation device comprising:
a first force-transferring element;
a second force-transferring element;
a first energy dissipation element;
where the first and second force-transferring elements are, with the aid of the first energy dissipation element, connected to one another in a force-locking manner such that tractive and impact forces can be transferred in the longitudinal direction of the energy dissipation device wherein the force flow taking place during the transfer of forces runs at least partially through the first energy dissipation element, where the first energy dissipation element is designed in such a manner that for up to a determinable first amount of energy transferred by the force flow over the first energy dissipation element, the first and second force-transferring elements are essentially rigid relative to one another in the longitudinal direction of the energy dissipation device and in case of an overshoot of the determinable first amount of energy transferred by the force flow over the first energy dissipation element, the force-transferring elements are shifted relative to one another in the longitudinal direction of the energy dissipation device, where at least a part of the transferred amount of energy is absorbed and dissipated by the first energy dissipation element;
wherein the energy dissipation device further comprises at least one second energy dissipation element which is disposed in relation to the first and second force-transferring elements in such a manner that tractive and impact forces are transferred in the longitudinal direction of the energy dissipation device wherein the force flow taking place during the transfer of forces runs at least partially through the at least one second energy dissipation element, where the at least one second energy dissipation element is designed in such a manner that for up to a determinable second amount of energy transferred by the force flow through the at least one second energy dissipation element, the first and second force-transferring elements are essentially rigid relative to one another in the longitudinal direction of the energy dissipation device and in case of an overshoot of the determinable second amount of energy transferred by the force flow over the at least one second energy dissipation element, the first and second force-transferring elements are shifted relative to one another in the longitudinal direction of the energy dissipation device, and where the first and second energy dissipation elements are disposed so as to be parallel to one another in such a manner that the force flow taking place during the transfer of the tractive and impact forces in the longitudinal direction of the energy dissipation device runs parallel through the first and second energy dissipation elements;
wherein the device is used as tractive and impact protection device in a multi-member vehicle.

14. The method of claim 13 wherein the device is used as a hinge or coupling arrangement of a rail vehicle.
